(19) United States
(12) Patent Application Publication
(10) Pub. No.: US 2019/0347747 A1
(43) Pub. Date: Nov. 14, 2019

(54) SYSTEM AND METHOD FOR EVALUATION OF REAL-ESTATE PROPERTY

(71) Applicant: Stoa Fund Ltd., Tel Aviv (IL)

(72) Inventors: Or AGASSI, Tel Aviv (IL); Tom SELLA, Miami, FL (US)

(73) Assignee: Stoa Fund Ltd., Tel Aviv (IL)

(21) Appl. No.: 16/519,700

(22) Filed: Jul. 23, 2019

Related U.S. Application Data
(63) Continuation-in-part of application No. 16/277,279, filed on Feb. 15, 2019.
(60) Provisional application No. 62/701,846, filed on Jul. 23, 2018.
(60) Provisional application No. 62/630,838, filed on Feb. 15, 2018.

(51) Int. Cl. G06Q 50/16; G06Q 40/02; G06Q 30/02

(52) U.S. Cl. CPC G06Q 50/16; G06Q 30/0278; G06Q 40/025

(57) ABSTRACT

A system and method for evaluating a real-estate property (REP). The method includes: receiving a location pointer associated with the REP; extracting metadata associated with the REP from a web source; extracting at least one multimedia content element associated with the REP; identifying relevant venues located in proximity to the REP based on the at least one multimedia content element; identifying a subdivision in which the REP is located based on an analysis of the metadata or the at least one multimedia content element; and, determining an evaluation of the REP based on the metadata, the at least one multimedia content element, and the identified venues.

### CROSS-REFERENCE TO RELATED APPLICATIONS

This application claims the benefit of U.S. Provisional Application No. 62/701,846 filed on Jul. 23, 2018. This application is also a continuation-in-part (CIP) of U.S. application Ser. No. 16/277,279, filed on Feb. 15, 2019 now pending, which claims the benefit of U.S. Provisional Application No. 62/630,838 filed on Feb. 15, 2018. All of the applications referenced above are herein incorporated by reference.

### TECHNICAL FIELD

The present disclosure relates generally to real-estate assessment tools, and more specifically to a system and method for automatically evaluating the value of a real-estate property.

### BACKGROUND

Even though advances in technology have become available in most industrial areas, the real-estate domain remains dependent on massive use of manual labor to perform tedious and costly tasks.

House flipping is a type of real estate investment strategy in which investors purchase properties with the goal of reselling them for a profit. Profit is generated either through the price appreciation that occurs as a result of a hot housing market and/or from developments and capital improvements to the property. Investors who employ these strategies face the risk of price depreciation in bad housing markets.

Investors who flip houses expect to generate a relatively high return from the houses purchased but may encounter cash-flow difficulties due to the nature of such strategies, which can require significant amounts of cash up front. Therefore, such investors typically use outsourced financing from different entities, such as banks, other financial institutes, or private lenders.

The loan process can be burdensome for an investor, who is often working on a hectic time frame. The complexity of the loan process is due to, among other reasons, the amount of time required by the lender for the evaluation of the value of the real-estate property for which the loan is required.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for evaluating a real-estate property (REP). The method includes: receiving a location pointer associated with the REP; extracting metadata associated with the REP from a web source; extracting at least one multimedia content element associated with the REP; identifying relevant venues located in proximity to the REP based on the at least one multimedia content element; identifying a subdivision in which the REP is located based on an analysis of the metadata or the at least one multimedia content element; and, determining an evaluation of the REP based on the metadata, the at least one multimedia content element, and the identified venues.

Certain embodiments disclosed herein also include a non-transitory computer readable medium having stored thereon instructions for causing a processing circuitry to perform a process, the process including: receiving a location pointer associated with the REP; extracting metadata associated with the REP from a web source; extracting at least one multimedia content element associated with the REP; identifying relevant venues located in proximity to the REP based on the at least one multimedia content element; identifying a subdivision in which the REP is located based on an analysis of the metadata or the at least one multimedia content element; and, determining an evaluation of the REP based on the metadata, the at least one multimedia content element, and the identified venues.

Certain embodiments disclosed herein also include a system for evaluating a real-estate property (REP), including: a processing circuitry; and a memory, the memory containing instructions that, when executed by the processing circuitry, configure the system to: receive a location pointer associated with the REP; extract metadata associated with the REP from a web source; extract at least one multimedia content element associated with the REP; identify relevant venues located in proximity to the REP based on the at least one multimedia content element; identify a subdivision in which the REP is located based on an analysis of the metadata or the at least one multimedia content element; and, determine an evaluation of the REP based on the metadata, the at least one multimedia content element, and the identified venues.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram of a real-estate property evaluation system according to an embodiment.

FIG. 2 is an example flowchart describing a method for evaluating real-estate property according to an embodiment.

FIG. 3 is an example flowchart describing a method for evaluating loan requests according to an embodiment.

FIG. 4 is an example schematic diagram of a server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for determining evaluations of real-estate properties based on metadata, multimedia content items, and identified nearby venues. The method further includes receiving a request for a desired loan and determining, based on a real-estate property evaluation and additional factors, if the loan should be approved.

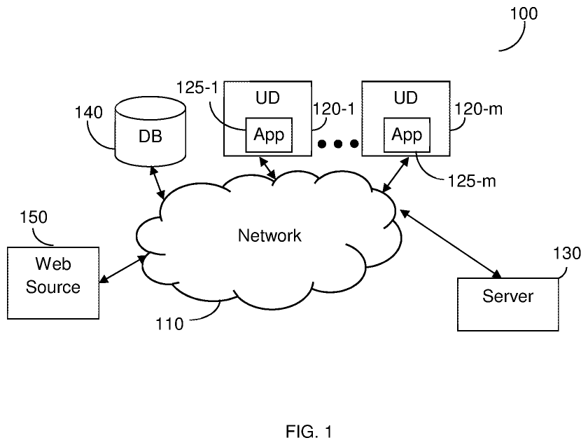

FIG. 1 is an example network diagram 100 of a real-estate property evaluation system 100 according to an embodiment. As illustrated in FIG. 1, a network 110 may be the Internet, the world-wide-web (WWW), a local area network (LAN), a wide area network (WAN), a metro area network (MAN), and other networks capable of enabling communication between the elements of the system 100.

Optionally, one or more user devices 120-1 through 120-m, where m is an integer equal to or greater than 1, hereinafter referred to as user device 120 for simplicity, are further connected to the network 110. A user device 120 may be, for example, a personal computer (PC), a personal digital assistant (PDA), a mobile phone, a smart phone, a tablet computer, an electronic wearable device (e.g., glasses, a watch, etc.) and other kinds of wired and mobile appliances, equipped with browsing, viewing, capturing, storing, listening, filtering, and managing capabilities enabled as further discussed herein below.

Each user device 120 may further include a software application (App) 125 installed thereon. The software application 125 may be downloaded from an application repository, such as the Apple AppStore®, Google Play®, or any repositories hosting software applications. The application 125 may be pre-installed on the user device 120. In one embodiment, the application 125 is a web-browser.

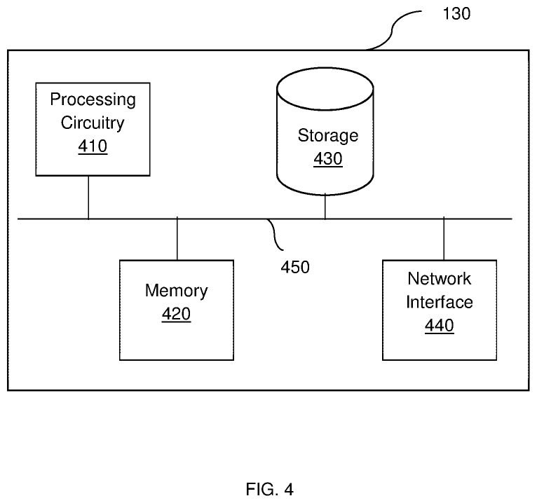

A server 130 is connected, over the network 110, to each user device 120 and can communicate therewith using the application 125 via the network 110. In an embodiment, the server 130 may be a physical device as illustrated in FIG. 4. In another embodiment, the server 130 may be virtual machine operable in a cloud computing platform. It should be noted that only one server 130 and one application 125 are discussed herein merely for the sake of simplicity. However, the embodiments disclosed herein are applicable to a plurality of user devices that can communicate with the server 130 via the network 110.

Also communicatively connected to the network 110 is a database 140 that stores metadata related to certain property transactions, data extracted from regulatory data sources and/or tax authorities, geographic information systems (GISs) home appliances' retailers, and more. In the embodiment illustrated in FIG. 1, the server 130 communicatively communicates with the database 140 through the network 110.

According to an embodiment, the server 130 is configured to receive at least one location pointer associated with at least one real-estate property. The location pointer may be received from a user device 120, via for example, the agent 125. The location pointer may be, for example, an address or a portion thereof, a geo-location, and the like.

Thereafter, the server 130 is further configured to extract metadata associated with the at least one real-estate property from at least one web source 150 over the network 110. The web source 150 may include, for example, governmental websites via the network, real-estate comparison websites (e.g., Zillow®), multiple listing sources and the like. The metadata may include, for example, parameters associated with prior transactions made with respect to other real-estate properties determined to be associated to the at least one real-estate property (REP), one or more second REPs in proximity to the at least one REP, previous transactions made with respect to the at least one REP, and so on.

One or more second REPs may be determined as associated with the at least one REP based on metadata such as for example, year built, number of rooms and/or bathrooms, size e.g., square feet, demographic data, crime rate, proximity to certain venues, weather, and so on.

According to an embodiment, the server 130 is further configured to extract at least one multimedia content element associated with the at least one REP. The multimedia content element may be an overhead image of the location, at least one image of a map associated with the REP, interior pictures of the REP, exterior pictures of the REP, and the like. Such images may be retrieved from public sources, such as Google® maps, and similar sources.

In an embodiment, the database 140 is configured to store a plurality of satellite or drone images. Thereafter, a surface outline of a surface, e.g., a rooftop, of the REP is identified. A pattern associated with the outlined surface is then determined by the server 130. The pattern may be recognized using machine learning techniques, image procession techniques, and the like.

Based on the multimedia content element, the server 130 is configured to identify relevant venues located in proximity to the REP. The relevant venues may include, for example, commercial venues, community venues, and so on, that are determined to be significant to potential purchasers, and are located within a predetermined threshold distance to the REP. The server 130 is further configured to determine the distance between the relevant venues and the REP.

The server 130 is further configured to identify a subdivision in which the REP is located. According to an embodiment, the server 130 is further configured to determine at least one parameter from the at least one REP respective of the multimedia content element as well as size parameters, e.g. square feet associated with the REP.

Based on the identified information, relevant metadata, and extracted multimedia, the server 130 is configured to determine a real-time evaluation of the at least one REP, e.g., a market price value of the property. The evaluation is calculated using available information related to the subdivision, an analysis of the at least one multimedia content element, the relevant metadata and the location pointer. According to an embodiment, once the evaluation is completed, the server 130 provides an indication of the evaluation to the user device 120.

According to a further embodiment, the server 130 is configured to perform as a loan request platform, wherein the server 130 receives at least one loan request for purchasing at least one REP, where the request includes at least a desired loan amount. According to this embodiment, the server 130 determines in real-time whether to approve a loan based on a match between the determined value of the at least one REP and the at least one loan request, for example, based on a predetermined approved ratio of a loan amount to a determined value. According to an embodiment, the server 130 may further include in the determination estimated foreclosure costs in a case where the loan terms are not subsequently met. Thereafter, an indication of whether or not the loan is confirmed is provided, e.g., to the user device 120.

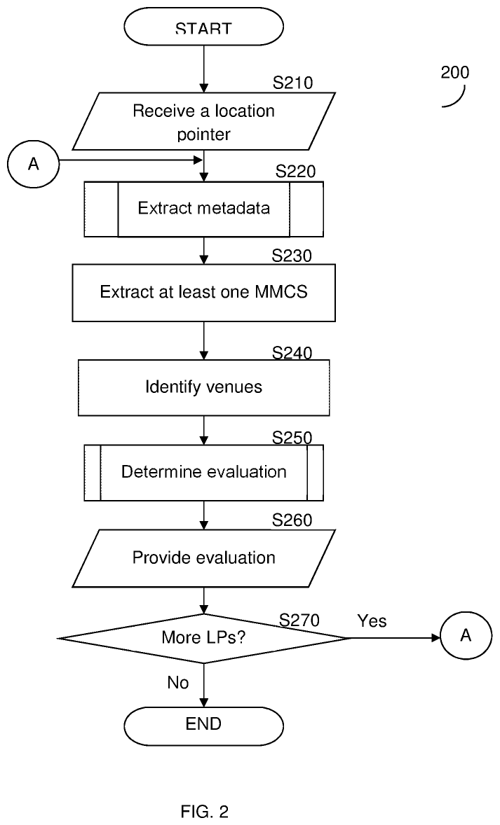

FIG. 2 shows an example flowchart 200 describing a method for evaluating real-estate property according to an embodiment. In an embodiment, the method is performed by the server 130 based on information received from at least one web source.

At S210, at least one location pointer associated with a REP under consideration is received, e.g., from a user device, such as the user device 120-1. The location pointer may be, for example, a physical address, a geo-location coordinates, and the like. The real estate property under consideration is a property being considered for an investment.

At S220, metadata associated with the property under consideration is extracted and identified. The metadata may include parameters associated with previous transactions made with respect to one or more second properties in proximity to the at least one property according to a predetermined threshold, previous transactions made with respect to the at least one property, and so on. The metadata may be extracted from, for example, external web sources, such as governmental websites via the network 110, real-estate comparison websites, such as, for example, Zillow®, a combination thereof, and so on.

At S230, at least one multimedia content element associated with the property under consideration is extracted, e.g., from the external web sources. The multimedia content element may include an overhead image of the location, at least one image of a map associated with the property, street level photos, interior photos, and the like. Such images may come from sources such as Google® maps and similar sources.

In an embodiment, the database 140 is configured to store a plurality of map images. Thereafter, a surface outline of a surface, e.g., a rooftop of the REP is identified. A pattern associated with the outlined surface is then determined by the server 130.

At S240, relevant venues in proximity to the REP are identified. The relevant venues may include, for example, commercial venues, community venues, and so on, that are determined to be significant to potential purchasers, and are located within a predetermined threshold distance to the REP. The server 130 is further configured to determine the proximity of the relevant venues to the REP. To this end, parameters are determined from the at least one REP based on the multimedia content element, such as size parameters, e.g., square feet associated with the property. Optionally, at S240, the location of a subdivision of the REP is identified.

At S250, an evaluation of the real estate property is determined. In an embodiment, the evaluation is determined based on at least the subdivision, an analysis of the at least one multimedia content element and the metadata.

In an embodiment, a weighted decision algorithm is utilized to compute the evaluation of the REP. Accordingly, each parameter collected with respect to the REP is assigned with a virtual value indicating the importance of the respective parameter to the evaluation. A weighted decision algorithm may be utilized to compute the value of the real estate property. Accordingly, each parameter collected with respect to the real estate property is assigned with a virtual value indicating the importance of the respective parameter to the evaluation.

As an example, data collected from a tax bureau indicating the current transaction made with respect of the REP may receive a higher virtual value than the determined parameters and therefore will be more significant in the determination of the evaluation of the REP. In one embodiment, the weighted decision algorithm is configured to compute the evaluation of the REP by taking an average of a sum of multiple virtual values.

The computation of virtual values of the parameters collected may be adjusted based on the total amount of data collected. For example, if only a few elements are collected, then each such collected element will be more significant in the evaluation determination. In one embodiment, the virtual values are computed using rules stored in a database 140. Each such rule sets that value for each piece of data collected for the evaluation, e.g., a value is assigned to a particular improvement or feature of a property, where a “virtual” value of the property is based on such rules.

At optional S260, the evaluation determination is provided as an output to, for example, the user device 120 of FIG. 1. At S270, it is checked additional location pointers have been received, and if so, execution continues with S220; otherwise, execution terminates.

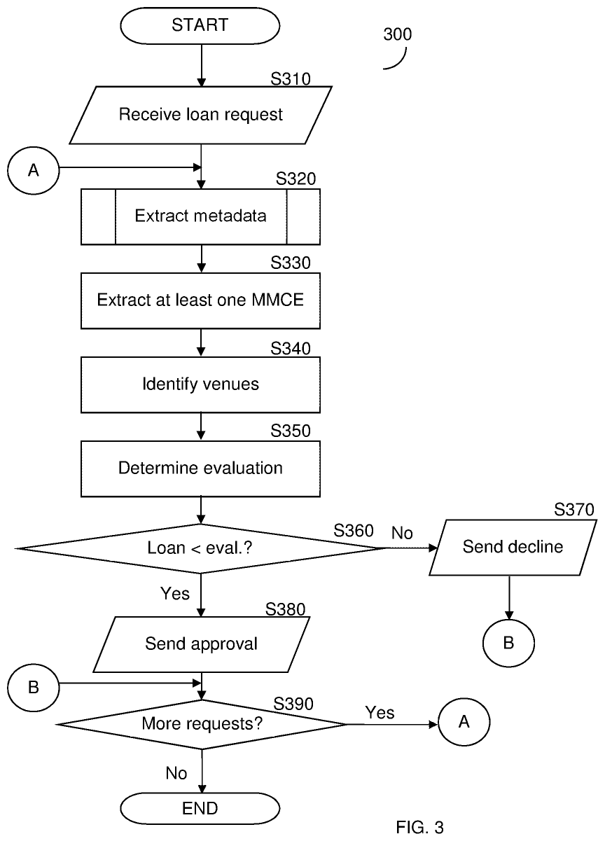

FIG. 3 depicts an example flowchart 300 describing a method for evaluating loan requests according to an embodiment. At S310, the operation starts when at least one loan request with respect of an REP is received, e.g., from a user device. The loan request includes at least one location pointer associated with the REP and a desired loan amount. The location pointer may be, for example, an address, a geo-location, etc.

At S320, metadata associated with the REP is identified. The metadata may include at least one of: parameters associated with previous one or more transactions made with respect to one or more second REPs in proximity to the at least one REP, previous transactions made with respect to the at least one REP, etc. The metadata may be extracted from, e.g., public databases, governmental websites, real-estate comparison websites, e.g., for example, Zillow®, combination thereof, and the like.

At S330, at least one multimedia content element associated with the at least one REP is extracted. The multimedia content element may be an overhead image of the location, at least one image of a map associated with the REP, exterior photos of the REP, interior photos of the REP, and the like. Such images may come from public sources such as Google® maps or like sources. In an embodiment, the images are retrieved from a database configured to store a plurality of earth map images where an outline of a surface, e.g., a rooftop of the REP, is identified and saved. A pattern associated with the outlined surface is then determined, e.g., by a server.

At optional S340, relevant venues in proximity to the REP are identified. The relevant venues may include, for example, commercial venues, community venues, and so on, that are determined to be significant to potential purchasers, and are located within a predetermined threshold distance to the REP. The proximity of the relevant venues to the REP may additionally be determined. Optionally, at S340, a subdivision in which the REP is located is identified based on analysis of the metadata or multimedia content elements. A subdivision is an area of land that is divided into smaller plots for individual properties. Some subdivisions include many identical or similar plots and properties, which makes estimating cost and evaluating price of a plot easier, as similar nearby plots can be used as accurate references. According to an embodiment, at least one parameter is determined from the at least one REP based on the multimedia content element, such as size parameters, e.g., square feet associated with the property.

At S350, an evaluation of the REP is determined based on at least the subdivision, an analysis of the at least one multimedia content element and the metadata. In an embodiment, a weighted decision algorithm is utilized to compute the evaluation of the REP. Accordingly, each parameter collected with respect to the REP is assigned with a virtual value indicating the importance of the respective parameter to the evaluation.

As an example, data collected from a tax bureau indicating the current transaction made with respect of the REP may receive a higher virtual value than the determined parameters and therefore will be more significant in the determination of the evaluation of the REP. In one embodiment, the weighted decision algorithm computes the evaluation of the REP, for example as an average sum of the virtual values.

The computation of virtual values of the parameters collected may be adjusted based on the total amount of data collected. For example, if only a few elements are collected, then each such collected element will be more significant in the evaluation determination. In one embodiment, the virtual values are computed using rules stored in a database 140. Each such rule sets that value for each piece of data collected for the evaluation, e.g., a value is assigned to a particular improvement or feature of a property, where a “virtual” value of the property is based on such rules.

At S360, it is checked whether the desired loan amount is lower that the evaluation and if so, execution continues with S380; otherwise, execution continues with S370. According to an embodiment, S360 further includes calculation of the estimated foreclosure costs for with respect of the REP in case the loan terms were not met and therefore, the check is whether the loan amount is lower that the evaluation together with the foreclosure costs.

At S370, a rejection notification is provided and execution continues with S390. At S380, an approval is provided to, for example, the user device 120. At S390, it is checked if additional requests have been received, and if so, execution continues with S320; otherwise, execution terminates.

FIG. 4 is an example schematic diagram of a server 130 according to an embodiment. The server 130 includes a processing circuitry 410 coupled to a memory 420, a storage 430, and a network interface 440. In an embodiment, the components of the server 130 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), GPUs, general-purpose microprocessors, microcontrollers, digital signal processors (DSPs), and the like, or any other hardware logic components that can perform calculations or other manipulations of information.

The memory 420 may be volatile (e.g., RAM, etc.), non-volatile (e.g., ROM, flash memory, etc.), or a combination thereof. In one configuration, computer readable instructions to implement one or more embodiments disclosed herein may be stored in the storage 430.

In another embodiment, the memory 420 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein. Specifically, the instructions, when executed, cause the processing circuitry 410 to evaluate real-estate property as discussed herein.

The storage 430 may be magnetic storage, optical storage, and the like, and may be realized, for example, as flash memory or other memory technology, CD-ROM, Digital Versatile Disks (DVDs), or any other medium which can be used to store the desired information.

The network interface 440 allows the server 130 to communicate with the user devices, web sources and data warehouse (shown in FIG. 1).

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for evaluating a real-estate property (REP), comprising:
receiving a location pointer associated with the REP;
extracting metadata associated with the REP from a web source;
extracting at least one multimedia content element associated with the REP;
identifying relevant venues located in proximity to the REP based on the at least one multimedia content element;
identifying a subdivision in which the REP is located based on an analysis of the metadata or the at least one multimedia content element; and,
determining an evaluation of the REP based on the metadata, the at least one multimedia content element, and the identified venues.

2. The method of claim 1, wherein the metadata includes at least one of: parameters associated with previous transactions made with respect to one or more second properties in proximity to the REP according to a predetermined threshold and parameters associated with previous transactions made with respect to the REP.

3. The method of claim 1, further comprising:
determining at least one parameter based on the at least one multimedia content element.

4. The method of claim 3, wherein each determined parameter is assigned with a virtual value indicating an importance of the respective parameter to the evaluation of the REP.

5. The method of claim 1, further comprising:
receiving at least one loan request for purchase of the REP, wherein the request includes at least one desired loan amount.

6. The method of claim 5, further comprising:
determining in real-time an approval of a desired loan request based on the determined evaluation of the REP and the at least one loan request.

7. The method of claim 6, wherein the approval includes determining whether the desired loan amount is lower that the evaluation of the REP.

8. The method of claim 6, further comprising:
providing an indication of the approval of the desired loan request to a user device.

9. The method of claim 1, where in the relevant venues in proximity to the REP include venues that are determined to be significant to potential purchasers and are located within a predetermined threshold distance to the REP.

10. A non-transitory computer readable medium having stored thereon instructions for causing a processing circuitry to perform a process, the process comprising:
receiving a location pointer associated with the REP;
extracting metadata associated with the REP from a web source;
extracting at least one multimedia content element associated with the REP;
identifying relevant venues located in proximity to the REP based on the at least one multimedia content element;
identifying a subdivision in which the REP is located based on an analysis of the metadata or the at least one multimedia content element; and,
determining an evaluation of the REP based on the metadata, the at least one multimedia content element, and the identified venues.

11. A system for evaluating a real-estate property (REP), comprising:
a processing circuitry; and
a memory, the memory containing instructions that, when executed by the processing circuitry, configure the system to:
receive a location pointer associated with the REP;
extract metadata associated with the REP from a web source;
extract at least one multimedia content element associated with the REP;
identify relevant venues located in proximity to the REP based on the at least one multimedia content element;
identify a subdivision in which the REP is located based on an analysis of the metadata or the at least one multimedia content element; and,
determine an evaluation of the REP based on the metadata, the at least one multimedia content element, and the identified venues.

12. The system of claim 11, wherein the metadata includes at least one of: parameters associated with previous transactions made with respect to one or more second properties in proximity to the REP according to a predetermined threshold and parameters associated with previous transactions made with respect to the REP.

13. The system of claim 11, wherein the system if further configured to:
determining at least one parameter based on the at least one multimedia content element.

14. The system of claim 13, wherein each determined parameter is assigned with a virtual value indicating an importance of the respective parameter to the evaluation of the REP.

15. The system of claim 11, wherein the system if further configured to:
receive at least one loan request for purchase of the REP, wherein the request includes at least one desired loan amount.

16. The system of claim 15, wherein the system if further configured to:
determine in real-time an approval of a desired loan request based on the determined evaluation of the REP and the at least one loan request.

17. The system of claim 16, wherein the approval includes determining whether the desired loan amount is lower that the evaluation of the REP.

18. The system of claim 16, wherein the system if further configured to:
provide an indication of the approval of the desired loan request to a user device.

19. The system of claim 11, wherein the relevant venues in proximity to the REP include venues that are determined to be significant to potential purchasers and are located within a predetermined threshold distance to the REP.
